(19) United States
(12) Patent Application Publication
(10) Pub. No.: US 2006/0086523 A1
(43) Pub. Date: Apr. 27, 2006

(54) Mounting clip

(75) Inventor: Nguyen Tran, Garden Grove, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Mitsubishi Digital Electronics America, Inc.

(21) Appl. No.: 10/972,048

(22) Filed: Oct. 22, 2004

(51) Int. Cl. H02G 15/04

(52) U.S. Cl. 174/65 G

(57) ABSTRACT

The present invention is directed to a mounting clip that facilitates easy installation and removal of protective shields for PTVs and other video display units. The clip preferably comprises a base and an elongate locking arm extending generally orthogonally there from. The base is pivotally coupled at an end opposite the locking arm through a flexible coupling to a screen frame. The screen frame and clip are preferably integrally formed from PVC or other durable yet resilient material with the same, yet thinner, material coupling the base to the screen frame. A locking mechanism releasably locks the clip to the screen frame. In operation, the clip is rotated in a clockwise direction and the latch is snapped into the socket to secure a shield in place. The clip is rotated in a counter-clockwise direction to unlock the clip and remove the shield.

### FIELD OF THE INVENTION

The invention relates generally to projection television systems and more particularly to mounting clips for removable protective shields.

### BACKGROUND INFORMATION

Projection and other large screen televisions (PTVs), including monochrome cathode ray tube (CRT), liquid crystal on silicon (LCOS), digital light processing (DLP) and liquid crystal display (LCD) technology based PTVS, are a popular alternative to shadow mask CRT television sets, as they provide relatively large viewable screens that cannot be efficiently produced using conventional shadow mask CRTs. PTVs typically include an enclosure housing an optical unit and electronic components for receiving and projecting an image onto a screen assembly mounted on the front of the enclosure.

The screen of the PTV is typically a high-quality optical system that is carefully designed to deliver sharp, bright images with even illumination. PTV manufacturers often affix protective shields or screens formed from a hard clear or tinted plastic, acrylic or the like to the PTV to protect the projection screen from physical damage. Due to the generally large size of the shields and the mechanical means by which the shields are typically attached to the PTV, installing such shields in the factory and/or removing and re-installing the shields in the field at a customer's home tends to be quite difficult and cumbersome.

Accordingly, it would be desirable to provide a means that facilitates easy installation and removal of a protective shield.

### SUMMARY

The present invention is directed to a mounting clip that facilitates easy installation and removal of protective shields for PTVs and other video display units. The clip preferably comprises a base and an elongate locking arm extending generally orthogonally there from. The base is pivotally coupled at an end opposite the locking arm to a screen frame. The screen frame and clip are preferably integrally formed through injection molding or the like from PVC or other durable yet resilient material with the same, yet thinner, material providing a flexible coupling of the base of the clip to the screen frame.

A locking mechanism comprising a latch extending from the locking arm of the clip and a socket extending from the screen frame releasably locks the clip in a locked position.

In operation, the clip is rotated in a clockwise direction and the latch is snapped into the socket to secure a shield in place. The clip is rotated in a counter-clockwise direction to unlock the clip and remove the shield.

Other features and advantages of the invention will be or will become apparent to one with skill in the art upon examination of the following figures and detailed description.

### BRIEF DESCRIPTION OF THE FIGURES

The details of the invention, including fabrication, structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 is a partial side detail view of an assembly comprising a screen frame, a removable protective shield and a mounting clip in accordance with the present invention with the mounting clip in an unlocked position.

FIG. 2 is a partial side detail view of an assembly comprising a screen frame, a removable protective shield and a mounting clip in accordance with the present invention with the mounting clip in an locked position.

### DETAILED DESCRIPTION

The mounting clip described herein provides for easy installation and removal of a screen such as a protective screen or shield for a PTV or other display unit. The clip easily locks and unlocks the shield on to and removes it from the display unit. Preferably, the clip is integrally formed and pivotally coupled to a screen or display unit frame. The screen frame and clip are preferably integrally formed through injection molding or the like from PVC or other durable yet resilient material with the same, yet thinner, material providing a flexible coupling of the clip to the screen frame.

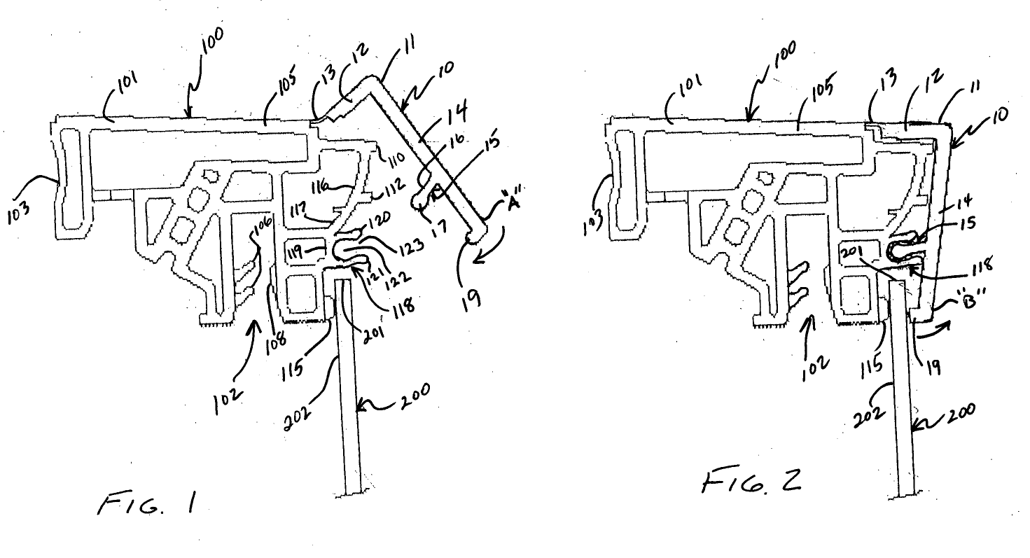

Referring in detail to the FIGS. 1 and 2, a partial assembly including the mounting clip 10, screen frame 100 and shield 200 of the present invention are shown in partial detail side view. As depicted, the mounting clip 10 is shown in an unlocked A and locked B position. The screen frame 100 to which the clip 10 is coupled preferably includes an extruded body 101 coupled on one end 103 to or integrally formed with an enclosure of a PTV or other display unit. As depicted, the screen frame 100 includes a screen retainer 102 formed as a recess in the body 101. The screen retainer 102 includes inwardly directed spring like retaining arms 106 and an abutment 108 against which the retaining arms urge a screen (not shown) against to retain the screen in place on a PVT.

The clip 10 preferably comprises, as depicted, an inverted, L-shaped body 11 including a base 12 and a locking arm 14 extending generally orthogonally from the base 12. The base 12 of the clip is coupled to an upper cross member 105 of the switch frame 100 via a connective member or flexible coupling 13 comprising a flexible, thinner yet resilient piece of material from which the screen frame 100 and clip 10 are formed. The connective member 13 enables the clip 10 to rotate from a locked position B to an unlocked position A while remaining flexibly coupled to the body 101 of the screen frame 100.

The screen frame 100 includes upper and lower stops 110 and 112 extending outwardly from an arcuate upper portion 116 of an end face 117 of the screen frame 100 to prevent the locking arm 14 of the clip 10 from rotating clockwise beyond the locked position B. Extending outwardly from the mid section 119 of the end face 117 of the body 101 of the screen frame 100 toward the clip 10 is a socket or catch 118 configured to releasably receive and couple with a latch 15 protruding inwardly from the locking arm 14 toward the screen frame 100. The socket 118 includes resilient spring like upper and lower arms 120 and 121 forming a generally circular cavity 122 with a constricted or narrowed opening 123. The latch 15 includes an elongate stem 16 extending at one end from the locking arm 14 and having a bulbous knob 17 formed on the other end of the stem 16. In a locked position B, the bulbous knob 17 is received in the cavity 122 of the socket 118. The latch 15 and socket 118 form a locking mechanism.

The locking arm 14 further includes a locking tab 19 extending inwardly toward the screen frame 100 from the locking arm 14 at an end opposite the base 12 of the clip 10. In a locked position B of the clip 10, the locking tab 19 presses the shield 200 against an shield abutment 115 formed on the end face 117 of the body 101 of the screen frame 100 to retain an end or edge 201 of the shield 200 in a space 20 formed between the clip 10 and screen frame 100.

In operation, the shield 200 is positioned with its internal face 202 adjacent its end or edge 201 against the shield abutment 115, then the locking arm 14 of the clip 10 is rotated clockwise from the unlocked position A to the locked position B. The clip 10 is locked in place at position B with the locking tab 19 urging the shield 200 against the shield abutment 115 by pressing the bulbous knob 17 of the latch 15 through the narrowed opening 123 of the socket 118 spreading the arms 120 and 121 apart. Once the knob 17 moves past the narrowed opening 123 and into the cavity 122, the resilient arms 121 spring back into position so their ends form the narrowed opening 123 releasably locking the knob 17 within the cavity 122 of the socket 118. The clip 10 is released or unlocked by pulling or rotating the locking arm 14 counter clockwise and, thus, pulling the knob 17 of the latch 15 through the narrowed opening 123 of the socket 118 to release the latch 15 and rotate the locking arm 14 counter clockwise.

In the foregoing specification, the invention has been described with reference to specific embodiments thereof. It will, however, be evident that various modifications and changes may be made thereto without departing from the broader spirit and scope of the invention. Features and processes known to those of ordinary skill may be incorporated as desired. Additionally and obviously, features may be added or subtracted as desired. Accordingly, the invention is not to be restricted except in light of the attached claims and their equivalents.

What is claimed is:

1. A display unit comprising
a screen frame,
a mounting clip, and
a flexible coupling connecting the mounting clip to the screen frame.

2. The display unit of claim 1 wherein the screen frame, mounting clip and flexible coupling are integrally formed.

3. The display unit of claim 2 wherein the screen frame, mounting clip and flexible coupling are injection molded.

4. The display unit of claim 3 wherein the screen frame, mounting clip and flexible coupling are formed of PVC.

5. The display unit of claim 4 wherein the clip is L-shaped.

6. The display unit of claim 5 wherein the clip includes a base and a locking arm extending orthogonally there from.

7. The display unit of claim 1 wherein the clip is movable between a locked and unlocked position.

8. The display unit of claim 1 further comprising a locking mechanism releasably locking the clip in a locked position.

9. The display unit of claim 8 wherein the locking mechanism comprises a socket and a latch releasably coupleable to the socket.

10. The display unit of claim 7 further comprising a stop formed on the screen frame to prevent the clip from rotating beyond a locked position.

11. A screen frame comprising
a body, and
a mounting clip flexibly coupled to the body.

12. The screen frame of claim 11 wherein the body and mounting clip are integrally formed.

13. The screen frame of claim 12 wherein the body and mounting clip are injection molded.

14. The screen frame of claim 13 wherein the body and mounting clip are formed of PVC.

15. The screen frame of claim 14 wherein the clip is L-shaped.

16. The screen frame of claim 15 wherein the clip includes a base, a locking arm extending orthogonally there from and a coupling member connecting the base of the clip to the body.

17. The screen frame of claim 11 wherein the clip is movable between a locked and unlocked position.

18. The screen frame of claim 11 further comprising a locking mechanism releasably coupling the clip to the body.

19. The screen frame of claim 18 wherein the locking mechanism comprises a socket and a latch releasably coupleable to the socket.

20. The screen frame of claim 17 further comprising a stop formed on the body to prevent the clip from rotating beyond a locked position.
